(19) United States
(12) Patent Application Publication
(10) Pub. No.: US 2006/0041420 A1
(43) Pub. Date: Feb. 23, 2006

(54) Method and apparatus for configuring a network appliance

(75) Inventors: James T. Martin, Santa Rosa, CA (US); David James Evans, Petaluma, CA (US); Herman Vis, Santa Rosa, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Threshold Corporation, Santa Rosa, CA (US)

(21) Appl. No.: 11/173,802

(22) Filed: Jun. 30, 2005

Related U.S. Application Data
(60) Provisional application No. 60/584,731, filed on Jun. 30, 2004.

(51) Int. Cl. G06F 9/455

(52) U.S. Cl. 703/27

(57) ABSTRACT

To establish communication between a host and a client, electromagnetic field is generated across coils disposed in the devices. The magnetic field generated across the coil disposed in the host is used to power the client and to transfer data to the client. The data received by the client may, in turn, be used to configure the client. To receive data from the client, the coil disposed in the host is placed in a quiescent data recovery mode. The data to be transmitted from the client to the host generates variations in magnetic field formed across the client's coil. These variation, in turn, form variations in the magnetic field across the coil disposed in the host, and are subsequently decoded by the host to detect the data transmitted from the client. Supporting circuitry in both the host and client convert the electromagnetic variations into a stream of bits.

### CROSS-REFERENCES TO RELATED APPLICATIONS

The present application claims benefit under 35 USC 119(e) of U.S. provisional application No. 60/584,731, filed Jun. 30, 2004, entitled “Method And Apparatus For Configuring A Network Appliance”, the contents of which is incorporated herein by reference in its entirety.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The need to set up, configure and expand various computing and communication devices in small offices or homes is on the rise. Even with the adoption of WLAN, many users find it difficult to set up their home or small office network. Often, the network ends up being set to the mode the user initially configures it rather than what is optimal for that user. Many WLAN networks are not operated in secure modes because of the intimidation of getting WEP keys synchronized across multiple devices. If the digital home or office is to be truly adopted by the masses, then networking technology must be very simple to setup and operate.

### BRIEF SUMMARY OF THE INVENTION

In accordance with the present invention, to configure and initialize a peripheral device, the peripheral device (client) is brought into close proximity (e.g., between ¼ of an inch to one inch in some embodiments) of the server (host) such that a marked spot on the peripheral device is spaced adjacent a similarly marked device on the host. In some embodiments, the marked spots on both the host and client have blue colors. The blue spots are accordingly used to indicate the location of the configuration port.

Each of the host and client includes, in part, a coil across which an electromagnetic field is generated to induce inductive coupling. The magnetic field generated across the coil disposed in the host is used to power the client and to transfer data to the client. The data received by the client may, in turn, be used to configure the client. To receive data from the client, the coil disposed in the host is placed in a quiescent data recovery mode. The data to be transmitted from the client to the host generates variations in magnetic field formed across the client's coil. These variations, in turn, form variations in the magnetic field across the coil disposed in the host, and are subsequently decoded by the host to detect the data transmitted from the client. Supporting circuitry in both the host and client converts the electromagnetic variations into a stream of bits. The effective range of the devices is determined by the physical size of the coils, the drive power applied to the host coil, by the current required in the client circuitry and the frequency chosen for the host clock.

### BRIEF DESCRIPTION OF THE DRAWINGS

FIG. 1 is a schematic block diagram of a host and a client adapted to communicate via inductive coupling, in accordance with one embodiment of the present invention.

FIG. 2 shows various bytes of an exemplary message, in accordance with one embodiment of the present invention.

FIG. 3 shows various blocks disposed in a host adapted to communicate via inductive coupling, in accordance with another embodiment of the present invention.

FIG. 4 shows various blocks disposed in a client adapted to communicate via inductive coupling, in accordance with another embodiment of the present invention.

FIG. 5 is a component-level schematic view of the blocks shown in FIG. 3, in accordance with one embodiment of the present invention.

FIG. 6 is a component-level schematic view of the blocks shown in FIG. 4, in accordance with one embodiment of the present invention.

FIG. 7 is a timing diagram of a number of the signals associated with the schematics of FIGS. 5 and 6.

### DETAILED DESCRIPTION OF THE INVENTION

In accordance with the present invention, to configure and initialize a peripheral device, the peripheral (client) device is brought into close proximity (e.g., between ¼ of an inch to one inch in some embodiments) of the server (host) such that a marked spot on the peripheral device is spaced adjacent a similarly marked device on the host. In some embodiments, the marked spots on both the host and client have blue colors. The blue spots are accordingly used to indicate the location of the configuration port.

Each of the host and client includes, in part, a coil across which an electromagnetic field is generated to induce inductive coupling. The magnetic field generated across the coil disposed in the host is used to power the client and to transfer data to the client. The data received by the client may, in turn, be used to configure the client. To receive data from the client, the coil disposed in the host is placed in a quiescent data recovery mode. The data to be transmitted from the client to the host generates variations in magnetic field formed across the client's coil. These variations, in turn, form variations in the magnetic field across the coil disposed in the host, and are subsequently decoded by the host to detect the data transmitted from the client. Supporting circuitry in both the host and client converts the electromagnetic variations into a stream of bits. The effective range of the devices is determined by the physical size of the coils, the drive power applied to the host coil, by the current required in the client circuitry and the frequency chosen for the host clock.

The two devices can be a host device with access to a power source and a peripheral device that is permanently or temporarily un-powered. An example would be between a host device that has some computing power and a peripheral device that needs to be identified, classified or initialized. A second application of the invention may be to communicate between two redundant devices or systems one of which is temporarily without power.

Assume that a user purchases a home server kit that includes several networked peripherals in all of which the present invention may be embodied. Assume further that the peripherals include a clock radio, WLAN cordless telephone and a security camera. After powering and verifying operation of the home server, the process of adding and networking the peripheral devices to form the digital home network begins.

For example, the security camera is often a small battery-powered WLAN device that has no display or keypad. To add the camera to the home network, the user holds the camera's, e.g., blue spot adjacent the home server's blue spot. After a relatively shot time period, e.g., a few seconds, the security camera receives verification from the home server that the camera has been recognized and initialized for the home network. Through, for example, the home server front panel LCD, a browser window or the like, the user is subsequently asked a few questions about how the user would like to use the newly installed camera. A similar process of configuration may be carried out for the other peripheral devices.

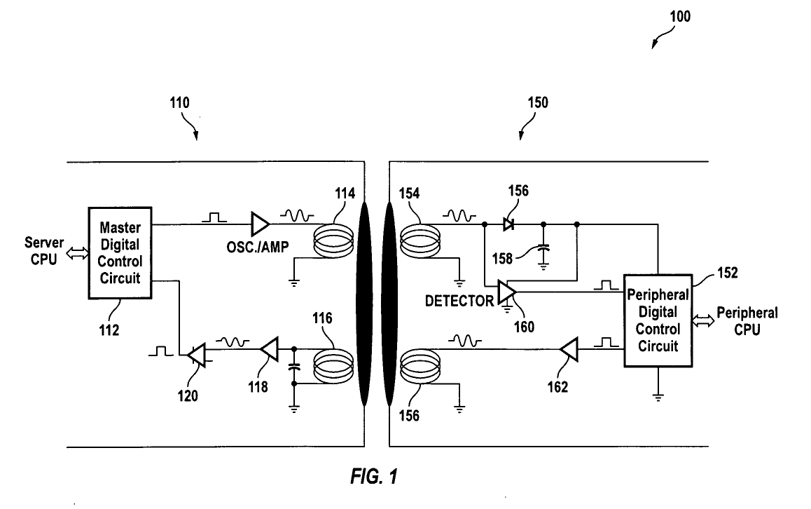

FIG. 1 is a schematic block diagram of a peripheral (client) 150 adapted to be configured using the home server (host) 110, in accordance with one embodiment of the present invention. The circuitry associated with the marked, e.g., blue, spot on the home server is shown as including, in part, a control unit 112, a transmit coil 114 adapted to transfer both data and power to client 150, and a receive coil 116. The circuitry associated with the marked, e.g., blue, spot, on the client is shown as including a control unit 152, a receive coil 154 adapted to receive both power and data, and a transmit coil 156.

During the initial configuration, the marked spot on client 150 is held in close proximity to the marked spot on the host. Physical contact between the two units is not required but may be used. The limited range of the operation is an important security feature, since this prevents eavesdropping by other parties and prevents interference to or from unintended devices that may be inside or outside the premises. In some embodiments, as describe below, a single inductor that is operated in a time-shared mode may be used in place of inductors 114, 116. Similarly, a single inductor that is operated in a time-shared mode may be used in place of inductors 154, 156. By placing the two marked spots of the host and client adjacent one another, the magnetic field of the coil 112 is coupled into and energizes coil 152. In other words, coils 112 and 152 form a transformer thereby enabling host 110 to be coupled to client 150. The magnetic field that is coupled into coil 154 is rectified by diode 156 and filtered by capacitor 158 to supply DC power to control unit 152.

Message Format

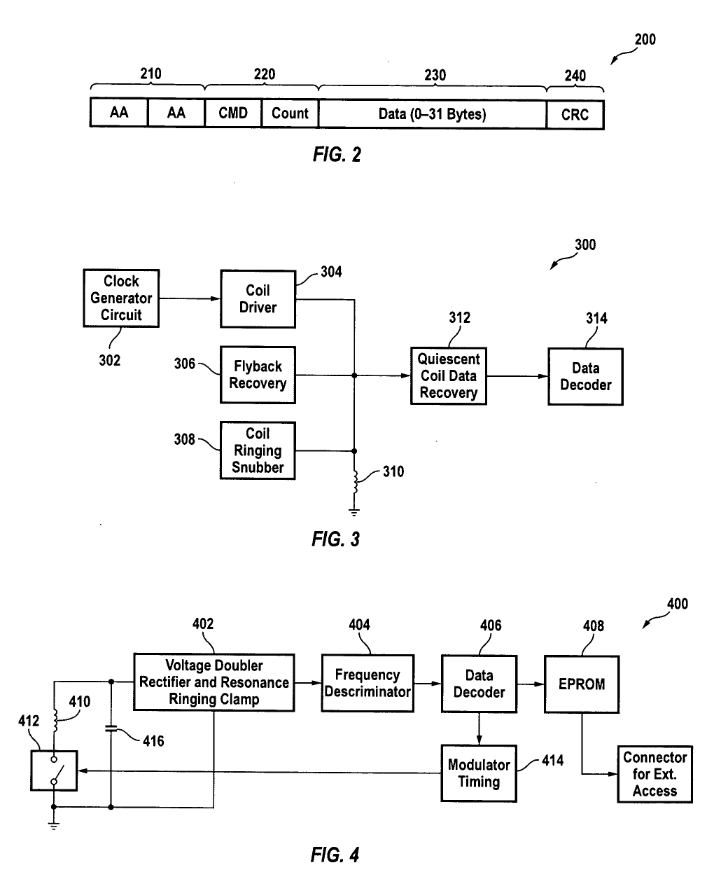

The following is an exemplary message format for use in accordance with the present invention. It is understood that other message formats may also be used. When a host 110 is invoked to configure a client 150, as selected, for example, by the user from a browser or from the LCD panel, the host circuitry transmits a continuous stream of, for example, hexadecimal “66” bytes to power up the client. When the client 150 acquires sufficient power via host 110 to operate, it responds with a continuous stream of messages to indicate that is powered up. Upon recognizing and detecting the message that the client is power-up, the host sends a command to the client to read the device data. Then, depending on the device type, the host sends configuration data to the peripheral, using one or more “command write” messages. The client device acknowledges each command, and if any messages are not properly acknowledged, the host will repeat the sequence. After the last command is properly acknowledged by the client, the host reports back for display to the LCD control software or browser control software, and the user is notified by visual and/or auditory devices disposed in the host. FIG. 2 shows the byte sequence of the messages 200 in accordance with one exemplary embodiment. The exemplary messages 200 includes a synchronization sequence (two hexadecimal “AA” bytes) 210, a command/count sequence (two bytes) 220, a data sequence (zero to 31 bytes) 230, and a check byte (CRC8 error detection byte) 240.

The CMD byte of the command/count sequence 220 indicates the type of operation, e.g., read device data, command write, etc. The Count byte of the command/count sequence 220 indicates the number of data bytes in the message. The CRC byte 240 enables the receiver to detect errors, so that improperly formatted messages are inhibited from causing erroneous configuration.

Protocol

The Following is an exemplary protocol for configuring a client device, in accordance with one embodiment of the present invention. It is understood that other protocols may also be used. First, circuitry 110 disposed in the host begins sending a signal that creates a varying magnetic field in inductor 114. After circuitry 150 disposed in the client device is brought into close proximity circuitry 110, the magnetic field through coil 114 induces electrical current to flow in circuitry 150 via two paths. The first path is through a low voltage-drop diode 156 and capacitor 158, thereby generating a DC voltage adapted to power peripheral control circuit 152. The second current path is through differentiating edge detector 160 adapted to demodulate the message data.

The host using the control circuit 112 on a periodic basis transmits by way of frequency shift keying (FSK) modulation of the host coil 114 power signal an “are you there?” message. When a client is brought within range of the host signal, the receive coil 154 provides both signal and power to the client control circuit 152 which decodes the “are you there?” message and responds by way of the modulator 162 with “yes, I am reset”. The client sends this information to the host by modulating the circulating current in the client 154 and/or 156 coil.

The host receive 114 and/or 116 coil is arranged so that in between each power clock/FSK pulse there is a quiescent period. During this quiescent period, the host receiver 118 looks for magnetic disturbances in the receive coil 114 and/or 116. These disturbances are caused by circulating current in the client coil 154 and/or 156. The client is able to allow or disallow this circulating current in the client coil 154 and/or 156, and the host receiver 118 can differentiate whether the client circulating current is or is not present. These indications are converted to logic levels by a comparator 120 passed to the host control circuit 112.

After the host circuit receives the “yes, I am reset” signal from the client, thereby informing the host that there is a functioning client in proximity), the host proceeds to the configuration process. The configuration of a peripheral device by the host includes a sequence of command/data message blocks, followed by a verification command. Each message may include a header field, an optional data block field, and an error-detecting check field. Since the host is adapted to communicate with one client at a time, specific device address information is not required to be included in the message headers. The inclusion of a check field for every message ensures that neither the host nor the client erroneously responds to spurious (noise) signals or other interference.

The contents of the header indicate the type of operation for that message, such as “are you there?”, “Read Device Information Data”, “Read Device Configuration Data”, “Write Device Configuration Data”, or “Acknowledge”. Information in the data field varies depending on the type of operation for that message. In every case, commands by the host is acknowledged (verified) within a certain time by the client device before proceeding. If the host receives an invalid or does not receive acknowledgment, the host repeats the entire sequence starting with “are you there?” This is practical because the total time cycle is very short and reduces the chance of the two devices getting out of command sequence. The final message may be a “Verification” command from the client device, and the configuration sequence is complete when the host confirms the validity of this message. Table I below shows a sequence of exemplary configuration message transmission for a typical client device.

TABLE I
Legend:

P: Data sent from peripheral
M: Data sent from master

WLAN Device
M: Command - Are you there?
P: yes, I am reset
M: Command - Read Device Data
P: Ack Command Read + Device Type / Model / Serial Number / MAC

Address / ECC

M: Command Write - WLAN Mode / Channel Number / Encryption

Mode / WEP Key / AP Identifier / DHCP Mode - Data / DNS Mode -
Data / WINS Mode - Data / Microsoft Network Name

P: Ack Command Write + Data Verification
X10 Device
P: I'm Alive
M: Command - Read Device Data
P: Ack Command Read + Device Type / Model / Serial Number / ECC
M: Command Write - Device ID
P: Ack Command Write + Data Verification
Ethernet Device
P: I'm Alive
M: Command - Read Device Data
P: Ack Command Read + Device Type / Model / Serial Number / MAC

Address / ECC

M: Command Write - DHCP Mode - Data / DNS Mode - Data / WINS

Mode - Data / Microsoft Network Name

P: Ack Command Write + Data Verification

FIGS. 3 and 4 respectively are block diagrams of the host circuitry (host) 300 and client circuitry (client) 400, in accordance with another embodiment of the present invention. Communication between host 300 and client 400 is carried out, in part, via a single coil 310 disposed in host 300 and a single coil 410 disposed in client 400. Host 300 is shown as including a clock generator 302, a coil driver 304, a flyback recovery circuit 306, a coil ringing snubber 308, a coil 310, a quiescent coil data recovery circuit 312, and a data decoder 314. Client 400 is shown as including a voltage doubler rectifier and resonance ringing clamp circuit 402, a frequency discriminator 404, a data decoder 406, a memory 408, a coil 410, a switch 412, a modulator timing circuit 414, and a capacitor 416.

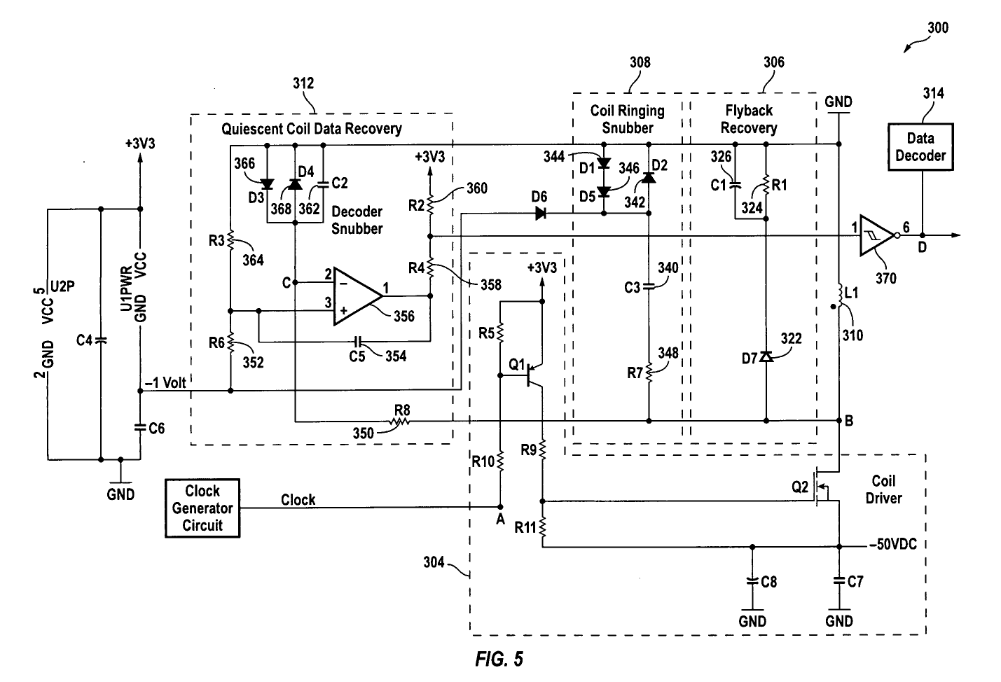

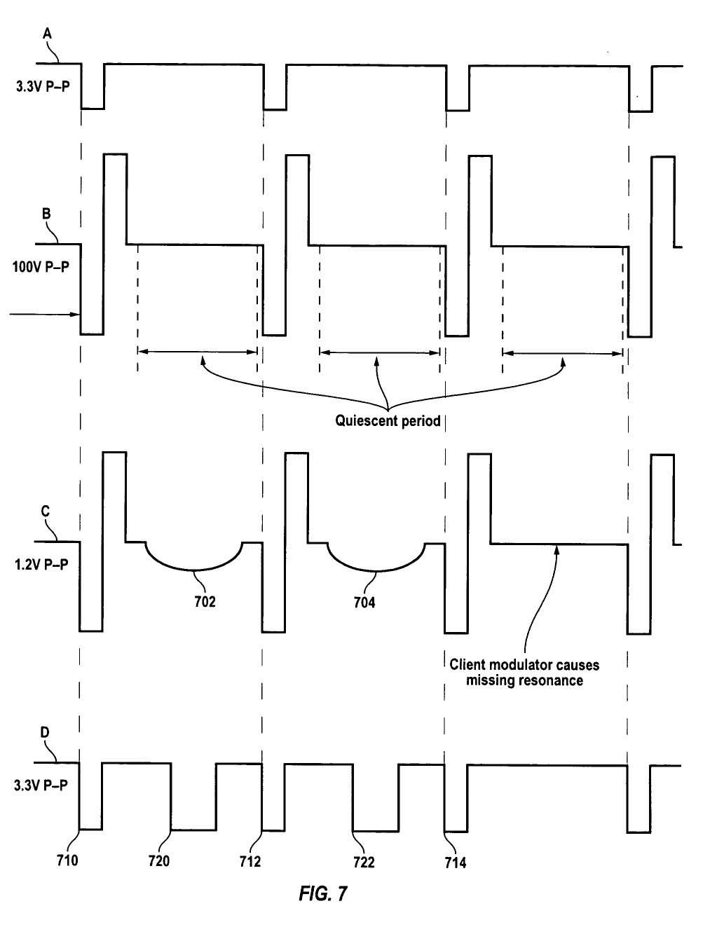

FIG. 5 is a more detailed schematic representation of some of the components disposed in host 300, in accordance with one embodiment of the present invention. Clock generator circuit 302 supplies a clock signal CLK that is applied to node A. In accordance with the PSK technique, signal CLK runs at two different frequencies depending on whether a one or a zero is to be transmitted from the host to the client. In one embodiment, signal CLK runs at 10.33 KHz when host 300 is transmitting zeroes to client 400, and at 11.48 KHz when host 300 is transmitting ones to client 400. When client 400 is transmitting data to host 300, the frequency of signal CLK remains fixed at 10.33 KHz. FIG. 7 shows the waveform of signal CLK as a function of time.

Exemplary flyback recovery circuit 304 is configured to capture coil 310's flyback energy when the drive signal is removed. Flyback recovery circuit 310 is shown as including a diode 322, a resistor 324 and a capacitor 326, whose values are selected so as to create a flyback pulse of equal but opposite amplitude with equal duration as the active drive signal. As shown in FIG. 7, the initial coil pulse is negative 50 volts and the resulting flyback pulse is positive 50 volts. Because the values of the components, e.g., resistor 324, disposed in flyback recovery circuit 306 are selected so as to generate a flyback pulse at node B of the same amplitude as the drive pulse supplied at node A, the pulse at node B has the same duration as the pulse at node A. Client 400 and host 300 are configured to synchronize their timing using the pulse supplied by the host at node B.

Coil driver 304 is adapted to control the pulse width of the clock signal CLK supplied to node A so that coil 310 is driven by clock generator circuit 302 or flyback recovery circuit 306 about 25% of the time in some embodiments. In accordance with the present invention, this is to done to allow the single coil 310 to transmit power and host data so that during a receive quiescent interval when host receives data from client 300, coil 310 is not coupled to a voltage source. By having the coil available during a predefined clock period, detection of any signals sent from the client towards the host is facilitated in accordance with the present invention.

Coil ringing snubber 308 is adapted to include diodes 342, 344, 346, capacitor 340 and resistor 348, which are selected so as to dampen the voltage ringing consequent to supplying the pulse to coil 310. The diodes are adapted to decouple resistor 348 and capacitor 340 when the ringing signal drops below one diode drop or approximately 0.6 Volts, thereby preventing coil ringing snubber 308 from attenuating the signal received from client 400. In other words, Coil ringing snubber 308 is configured to ensure that coil 310 is in a quiescent mode when data is being transmitted from client 400 to host 300.

Quiescent coil data recovery circuit 312 includes, in part, a comparator 356 and a pair of anti-parallel diodes 366 and 368. Resistors 352 and 364 form a resistor divider voltage providing a reference voltage to terminal I0 of comparator 356. The voltage at node B is supplied to a first terminal of resistor 350 having a second terminal coupled to node C that is also coupled to the second input terminal I1 of comparator 356. Resistor 350 has a relatively large resistance, e.g. 10K, which together with anti-parallel diodes 366, and 368 are configured to inhibit the large voltage variations at node B from adversely affecting comparator 356 and further ensuring that the voltage on node C is clamped to ±0.6 volts, assuming that the breakdown voltage of the diodes is 0.6 volts. Quiescent coil data recovery circuit 312 is adapted to detect the relatively small voltage variations in the host coil 310 caused by circulating resonant current in the client tank circuit formed by resonance capacitor 416 and receive coil 410. As is seen from FIG. 7, the voltage signal on node C varies between +0.6 volts and −0.6 volts. Disturbances 702 and 704 on the voltage signal on node C are caused by the circulating current in the resonant tank of client 400.

Coil 410 disposed in client 400 is tuned to be resonant at twice the host clock frequency. When the client coil 410 is brought into proximity of coil 310, the circulating current in the client 400 resonant tank circuit disturbs the host coil 310 in such a way that the comparator 356 output changes states in the time period between the host clock periods. These disturbances, identified with reference numerals 702 and 704 in FIG. 7 on the voltage signal on node C, are caused by the circulating current in the resonant tank of client 400. Accordingly, when such a disturbance is detected as being present on node C, a logic one is identified as having been transmitted by client 400 to host 300, and when no such disturbance is detected as being present on node C, a logic zero is identified as having been transmitted by client 400 to host 300.

The output signal of comparator 356 is supplied to one of the terminals of resistor 358 whose other terminal drives the input terminal of buffer 370. Resistor 360 is also disposed between the supply voltage and the input terminal of buffer 370. Buffer 370 is adapted to invert and buffer the signal received from the comparator. Buffer 370 is also an Schmitt trigger adapted to eliminate or minimize any residual noise that may be present at the output of comparator 356. The output terminal of buffer 370 is coupled to node D which has a timing diagram as shown in FIG. 7. Drive pulses on node D are identified with reference numerals 710, 712, and 714. Data pulses received from client 400 are identified with reference numerals 720, and 722. Data pulse 720 corresponds to disturbance 702 on the signal at node C, and data pulse 722 corresponds to disturbance 722 on the signal at node C.

FIG. 7 is a more detailed schematic representation of some of the components disposed in client 400, in accordance with one embodiment of the present invention. Capacitor 416 and inductor 410 form a resonant tank circuit. When transistor switch 412 is closed, inductor 410 is coupled to capacitor 416, thereby enabling client 400 to transmit data synchronously with respect to the clock signal of host 300. When transistor switch 412 is open, inductor 410 is decoupled from capacitor 416, thereby inhibiting client 400 from transmitting data to host 300. The resonant tank is tuned to the host clock frequency. Since the host is frequency modulated, the tuning is adjusted to equal the geometric center frequency of the two frequencies used by the host. Transistor 412 is opened and closed in response to the signal supplied by microprocessor 600.

Voltage doubler rectifier and resonance ringing clamp circuit 402 is shown as including diodes 802, 804 and capacitors 806, 808. Diodes 802, 804 and capacitor 808 form a voltage doubler, the output of which is supplied and stored in storage capacitor 806. Storage capacitor 806 is the source of power for client 400 when it is communicating with the host.

Microprocessor 600 includes frequency discriminator 404, data decoder 406, and the storage memory 408 (FIG. 4). Input terminal GP2 of microprocessor 600 receives the signal from the resonant tank via capacitor 808 and resistor 820 and supplies this signal to the frequency discriminator block. The frequency discriminator block is configured to decode digital serial data stream received from the host and to derive timing information therefrom. The frequency discriminator block may be implemented in software or hardware within the microprocessor. The derived timing information is applied to switch 412 via output pin GP4/Cout of microprocessor 600 and capacitor 822. Voltage doubler 402 also provides a voltage clamp for the frequency discriminator input. This limits the frequency discriminator input signal positive and negative peaks to be equal in amplitude to the power supply voltage of the client. The remaining pins of microprocessor 600 are used to read the content of the non-volatile memory, e.g. EPROM disposed in the microprocessor 600.

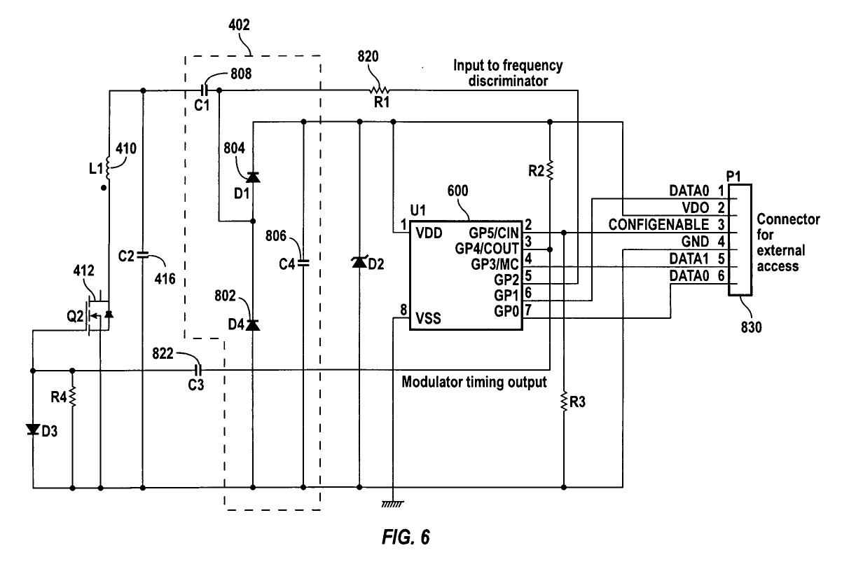

Since power is terminated when the host completes communications with the client, the host data is further stored in the non-volatile memory 408. As described above, in the embodiment shown in FIG. 6, the non-volatile memory is disposed in microprocessor 600.

If requested by the host, the client may send any information stored in the non-volatile memory device back to the host. Such data may have been supplied earlier by the host or may be any other data, such as an identifying signature previously stored in the memory, for example, during manufacturing. Connector 830 shown in FIG. 6 is used to access the data stored in the memory disposed in microprocessor 600.

As described above, the signals applied to switch (modulator) 412 are timed to be coincident with the host clock signals and have duration equal to an exact multiple of the host clock. The maximum duration of these signals is limited by the capacitance of storage capacitor 806 since host power becomes unavailable when the resonant tank is temporarily not resonant. Typically the rate can not exceed every other host clock cycle because the resonant tank is required to maintain a charge on the power storage capacitor 806.

The above embodiments of the present invention are illustrative and not limiting. Various alternatives and equivalents are possible. The invention is not limited by the type of encoding, decoding, modulation, demodulation, coil driver, flyback recovery, coil ringing snubber, quiescent coil data recovery, voltage doubler, frequency discriminator, etc. The invention is not limited by the rate used to transfer the data. The invention is not limited by the type of integrated circuit in which the present disclosure may be disposed. Nor is the disclosure limited to any specific type of process technology, e.g., CMOS, Bipolar, or BICMOS that may be used to manufacture the present disclosure. Other additions, subtractions or modifications are obvious in view of the present disclosure and are intended to fall within the scope of the appended claims.

What is claimed is:

1. A device configured to establish communication via a magnetic field, said device comprising:
a coil;
a coil driver coupled to the coil and adapted to receive a clock signal;
a flyback recovery circuit coupled to the coil; wherein said coil driver and said flyback recovery circuit are adapted to induce magnetic field in the coil during a first time period;
a coil ringing snubber coupled to the coil; and
a quiescent data recovery circuit coupled to the coil; wherein said data recovery circuit is adapted to receive data via the coil during a second time period during which said coil is in a quiescent mode.

2. The device of claim 1 further comprising:
a coil ringing snubber coupled to the coil and adapted to ensure that the coil is in a quiescent mode when data is being received by the device.

3. The device of claim 2 wherein said clock signal is configured to run at a first frequency when a one is transmitted by the device and at a second frequency when a zero is transmitted by the device.

4. The device of claim 3 wherein said clock signal is configured to run at the either frequency when the coils is in a quiescent mode.

5. The device of claim 4 wherein said device further comprises a marked spot on its exterior surface to indicate position of the coil disposed in the host device.

6. The device of claim 5 further comprising:
a data decoder coupled to the quiescent data recovery circuit and configured to decode data received therefrom.

7. The device of claim 6 wherein said host device is configured to supply power to a peripheral device when brought into proximity thereof.

8. A device configured to establish communication via a magnetic field, said device comprising:
a coil;
a resonant capacitor coupled to the coil; and
a switch adapted to couple the coil to the capacitor when said device is in a mode to transmit data magnetically via the coil, and wherein said switch is further adapted to decouple the coil from the capacitor when said device is in a mode to receive data magnetically via the coil.

9. The device of claim 8 wherein said device further comprises:
a voltage doubler adapted to double a voltage generated from a stream of bits received via the coil.

10. The device of claim 9 wherein the coil disposed in the device is tuned to be resonant at multiple of a clock frequency of a second coil disposed in a second device when the second coil is brought into proximity of the first coil.

11. The device of claim 10 wherein the device further comprises:
a frequency discriminator;
a data decoder; and
a modulator.

12. The device of claim 11 further comprising:
a storage capacitor adapted to store charges due to a magnetic field formed in the first coil in response to a magnetic field formed in the second coil.

13. The device of claim 12 wherein the frequency discriminator, the data decoder, and the modulator are formed in a processor disposed in the device.

14. The device of claim 13 wherein said storage capacitor is further adapted to supply the voltage generated by the voltage doubler to the processor.

15. The device of claim 14 wherein said processor is further configured to provide a control signal for turning the switch on or off.

16. The device of claim 14 wherein said device further comprises:
a non-volatile memory.

17. A system comprising a host device and a client device, wherein said host is adapted to supply power to the client device and is further adapted to configure the client device when a first coil disposed in the host device is brought into close proximity of a second coil disposed in the client device, wherein said host device comprises a coil driver coupled to the first coil and adapted to receive a clock signal and to supply a drive signal to the first coil, and wherein said client device comprises a resonant capacitor coupled to the second coil, wherein a first magnetic field is formed in said first coil during a first time period and in response to the drive signal to supply power and data to the client device, and wherein a second magnetic field is formed in said first coil during a second time period and in response to a third magnetic field generated in the second coil, wherein said third magnetic field is generated to transmit data from the client device to the host device.

18. The system of claim 17 wherein said host system further comprises:
a flyback recovery circuit coupled to the first coil;
a coil ringing snubber coupled to the first coil;
a quiescent data recovery circuit coupled to the first coil; wherein said data recovery circuit is adapted to receive data via the first coil during the second time period during which said first coil is in a quiescent mode and said coil is transmitting data from the client device to the host device; and
a coil ringing snubber coupled to the first coil and adapted to ensure that the first coil is in a quiescent mode when data is being received by the host device.

19. The system of claim 18 wherein both the host and client have marked spots on their exterior surfaces to indicate positions of the respectively first and second coils disposed therein.

20. The system of claim 18 wherein said host device receives a clock signal configured to run at a first frequency when a one is transmitted by the host device to the client device and at a second frequency when a zero is transmitted by the host device to the client device.

21. A method of establishing communication between a first device and a second device, the method comprising:
placing the first device adjacent the second device;
establishing a magnetic field in a coil disposed in the first device in response to a drive signal generated by the first device;
coupling the magnetic field established in the first coil to a second coil disposed in the second device;
using the magnetic field coupled to the second coil to power up the second device;
using the magnetic field coupled to the second coil to supply data from the first device to the second device.

22. The method of claim 21 further comprising:
placing the first coil in a quiescent data recovery mode to enable the first device to receive data from the second device;
establishing a magnetic field in the second coil in response to a signal generated in the second device;
coupling the magnetic field established in the second coil to the first coil;
using the magnetic field coupled to the first coil to supply data from the second device to the first device.
